(19) United States
(12) Patent Application Publication
(10) Pub. No.: US 2007/0105081 A1
(43) Pub. Date: May 10, 2007

(54) Apparatus for swimmer protection and uses thereof

(76) Inventor: Rainer A. Del Valle, Lafayette, CA (US)

Correspondence Address: Christopher Alan Schmidt & Associates, PLLC, Suite 103, 860 Greenbrier Circle, Chesapeake, VA, 23320, US

(21) Appl. No.: 11/267,008

(22) Filed: Nov. 4, 2005

(51) Int. Cl. A63B 69/00; G09B 19/00

(52) U.S. Cl. 434/247

(57) ABSTRACT

A novel apparatus and method that would enable the parents or volunteers in easily and effectively protecting the young participants from striking the crown of their heads against the pool edge at the completion of swimming the backstroke without obstructing the stroke of the swimmers as they complete swim “into the wall” is disclosed. The protection apparatus comprises a handle and a cushion or pad attached to the bottom end of the handle. Preferably, the handle comprises a tubular shaft having a length that would enable a user to remain in a standing position while using the protection apparatus. Alternately, the handle can be designed to have an adjustable length. The cushion is made of protective material such as foam or an inflatable device. Preferably, the front side and the back side of the cushion each is shaped in the form of a trapezoid. However, other shapes for the cushion are workable. Optionally, a cap is attached to the top end of the handle. The protection apparatus can also be used as a means of notification to the swimmer that the pool wall is near.

### BACKGROUND OF THE INVENTION

A. Field of the Invention

This invention pertains to the general field of swimming pool related safety, and more particularly to a hand-held safety device to safeguard a swimmer from striking his or her head against the pool edge while swimming.

B. Description of Related Art

While undergoing training for or participating in swim meets, often young children strike their heads against the pool edge, and suffer a lot of discomfort, during the backstroke because they had not yet developed the proper technique to complete the stroke “into the wall,” which is rather important. If inadvertently, the head is struck against the pool edge with a force, then it is likely to cause significant injury. To guard against such injuries, often parents reach down and “catch” the children by placing their hands between the children's heads and the pool wall. The parents' hands would cushion the head from hitting the wall while alerting the child to stop the swim. This method is rather cumbersome and crude, and often ineffective, because it is generally difficult for the parents to reach over the edge of the pool and position their hands where the child's head will meet the wall. Furthermore, the dive platforms, which are centered and attached to the pool deck over some of the lanes for swim strokes, make it difficult and awkward to reach down with hands. Also many modem “no-wake” pools make such hand protection impossible because the distance between the water and the pool deck or edge can be anywhere from 1 foot to 3 feet. Therefore, a need exists for an inexpensive apparatus that would enable the parents or volunteers in easily and effectively protecting the young participants from striking the crown of their heads against the pool edge at the completion of swimming the backstroke without obstructing the stroke of the swimmers as they complete swim “into the wall.” Preferably, the protection device is sized such that it enables a selective placement of the device to protect the swimmer's head from striking the swimming pool edge, while leaving the edge around the swimmer not covered so as to allow the swimmer to touch the actual edge of the pool.

There are several approaches disclosed in the prior art for providing protection to swimmers as described below.

U.S. Pat. No. 5,134,730 to Vandis discloses a pool deck protective liner in the nature of a pool guard for swimmers extending around the deck of a swimming pool adjacent the edge of the deck at the swimming pool and along edges of structural components of the pool such as step ladders, diving boards and the like. The protective liner is comprised of a plurality of inflatable tubes which are sized and shaped to extend around the edges of the swimming pool deck and structural components thereof. Moreover, the individual tubes are endwise abuttable to form a generally peripherally extending liner. A member is provided on the inflatable tubes to hold the endwise abutted inflatable tubes along the edge of the swimming pool deck. U.S. Pat. No. 5,423,093 to Hall-Vandis also discloses a similar inflatable edge guard extending around the deck of a swimming pool providing protection to swimmers and others using the swimming pool by precluding hard contact with the pool edges.

U.S. Pat. No. 5,678,254 to Jardim discloses a border protector device comprising cushion modules fixed with back-end belts on hooks provided around the border of the pool.

U.S. Pat. No. 3,351,958 to Shields discloses cushioned copings for swimming pool walls, comprising a relatively thick sheet of spongy rubber-like material mounted on top of a wooden rail and bound with a resilient cover.

While the prior art described above serves to prevent impact between a swimmer's head and pool's edge, the protection apparatus is affixed to large segments or the entire length of the pool edge; and therefore it lacks in the important aspect of allowing the swimmer to touch the actual edge of the pool during the backstroke. Furthermore, the prior art protection pads generally require time consuming and cumbersome placement or removal; and in effect shorten the pool length by addition of the pad over the pool edge.

The instant invention disclosed herein provides an inexpensive apparatus that enables the parents or volunteers in easily and effectively protecting the young participants from striking the crown of their heads against the pool edge at the completion of swimming the backstroke without obstructing the stroke of the swimmers as they complete swim “into the wall.” The protection apparatus is sized such that it enables a selective placement of the apparatus to protect the swimmer's head from striking the swimming pool edge, while leaving the pool edge around the swimmer's head substantially not covered by the protection apparatus so as to allow the swimmer to touch the actual edge of the pool during the back stroke. Furthermore, the protection apparatus can be positioned as and when needed to prevent an injury that might otherwise occur below any affixed pool guard. Employing the safety apparatus during a swim meet is much quicker and more inexpensive than retrofitting a pool's edge with an affixed safety guard before each meet.

### SUMMARY OF THE INVENTION

In the first aspect of the invention, a novel apparatus and method that would enable the parents or volunteers in easily and effectively protecting the young participants from striking the crown of their heads against the pool edge at the completion of swimming the backstroke without obstructing the stroke of the swimmers as they complete swim “into the wall” is disclosed. The protection apparatus comprises a handle having a top end and a bottom end; and a cushion or a pad attached to the handle at the bottom end; wherein the cushion is placed, when desired, between a first object and a second object for providing protection to the second object when the second object strikes the first object. In one application of the invention, the first object is an edge of a wall of a swimming pool and the second object is the crown of the head of a swimmer. Other applications for the protection apparatus are possible.

In one aspect of the invention, preferably the handle has a length such that it would enable a user to remain in a standing position while using the protection apparatus. Alternately, the handle could be of a shorter length that would enable a user to remain in a sitting position while using the protection apparatus. In yet another embodiment of the invention, the handle is designed to have an adjustable length.

In another aspect of the invention, the handle is made from a PVC extrusion tubular shaft having ridges on the out side surface, and having the cross-section shaped in an oval shape. Alternately, the handle is made from a solid rod. Furthermore, the handle cross-section can be square, rectangular, or have any other shape.

In another aspect of the invention, the cushion is made of a protective material, or a combination of protective materials, such as for example EVA foam, PVC or an inflatable device.

In another aspect of the invention, the front side and the back side of the cushion each is shaped in the form of a trapezoid. However, other shapes, including a rectangular shape or a square shape, are possible for the front side and the back side of the cushion. Furthermore, the front side of the cushion and the back side need not be symmetrical. The preferred thickness for the cushion is 1.25 inches thick. However, other thicknesses for the cushion are possible.

In another aspect of the invention, a cap is placed on the top end of the handle. Different configurations and size for the cap are possible as well.

In yet another aspect of the invention, a method for protecting the crown of a swimmer's head from striking an edge of a wall of a swimming pool is disclosed. The method comprises the steps of: holding a protection apparatus comprising a handle and a cushion; the handle having a top end and a bottom end; the cushion being attached to the handle at the bottom end; and positioning the protection apparatus so that the cushion is placed between the edge of the wall of the swimming pool and the crown of the head of the swimmer. The protection in this manner can be accomplished by a person in a standing position or a sitting position.

In yet another aspect of the invention, a method of notification to the swimmer that the pool wall is near is disclosed. The method comprises the steps of: holding a protection apparatus comprising a handle and a cushion; the handle having a top end and a bottom end; the cushion being attached to the handle at the bottom end; and positioning the protection apparatus straight out over the pool for the swimmer to see the apparatus overhead before the swimmer drives his or her arm back and makes the final drive to the pool edge.

Further objects and advantages of the present invention will become apparent from consideration of the drawings and ensuing description thereof.

### BRIEF DESCRIPTION OF THE DRAWINGS

FIG. 1 illustrates application of a novel apparatus that enables parents or volunteers in easily and effectively protecting the young participants from striking the crown of their heads against the pool edge at the completion of swimming the backstroke without obstructing the stroke of the swimmers as they complete swim “into the wall,” according to the preferred embodiment of the invention.

FIG. 2 illustrates a perspective view of the swimmer head protection apparatus, according to a preferred embodiment of the invention.

FIG. 3 illustrates the front view of and preferred dimensions for the swimmer head protection apparatus shown in FIGS. 1 and 2, according to a preferred embodiment of the invention. Although not shown, the rear view of the protection apparatus is similar to the front view shown in FIG. 3. However, a different rear view of the protection apparatus is quite possible.

FIG. 3A illustrates the cross section of the protection apparatus taken along the section marked A-A in FIG. 3, according to a preferred embodiment of the invention.

FIG. 3B illustrates the cross section of the protection apparatus taken along the section marked B-B in FIG. 3, according to a preferred embodiment of the invention.

FIG. 4 illustrates an alternate configuration for the cap of the swimmer head protection apparatus, according to an alternate embodiment of the invention.

FIG. 4A illustrates the cross section of the cap and a portion of the handle of the swimmer head protection taken along the section marked A-A in FIG. 4, according to an alternate embodiment of the invention.

### DETAILED DESCRIPTION OF PREFERRED EMBODIMENT

Before describing the invention, first the background will be explained. During the recreational swim meets or practice or training, the children swim back and forth in their respective lanes. While near the edge of the swimming pool, the objective for the swimmer is to touch the edge of the pool while completing the backstroke; herein referred to as completing the swim “into the wall.” The swimming time is of the essence. The participant that finishes in the least amount of time is declared the winner of the swim meet. Therefore, the participants try to swim as fast as they can. It is very important for a participant to touch the edge of the pool while completing the backstroke, since failure to do so results in a penalty. Often, during such practice children strike their heads against the pool edge or the side of the pool during the backstroke, and generally suffer varying levels of discomfort, because they had not yet developed the proper technique to complete the stroke “into the wall.” If inadvertently, the head is struck against the pool edge with a force, then it is likely to cause significant injury. To guard against such injuries, often parents reach down and “catch” the children by placing their hands between the children's heads and the pool wall. The parents' hands would cushion the head from hitting the wall while alerting the child to stop the backstroke swim. This method is rather cumbersome and crude, and often ineffective, because it is generally difficult for the parents to reach over the edge of the pool and position their hands where the child's head will meet the wall. Furthermore, the dive platforms, which are centered and attached to the pool deck over some of the lanes for swim strokes, make it difficult and awkward to reach down with hands. Also many modem “no-wake” pools make such hand protection impossible because the distance between the water and the pool deck or edge can be as much as 3 feet. One skilled in the art would appreciate that the same scenario would prevail during an actual recreational swim meet.

Therefore, a need exists for an inexpensive apparatus that would enable the parents or volunteers in easily and effectively protecting the young participants from striking the crown of their heads against the pool edge at the completion of swimming the backstroke without obstructing the stroke of the swimmers as they complete swim “into the wall.” Preferably, the protection device is sized such that it enables a selective placement of the device to protect the swimmer's head from striking the swimming pool edge, while leaving the portion of the swimming pool edge around the swimmer not covered so as to allow the swimmer to touch the actual edge of the pool.

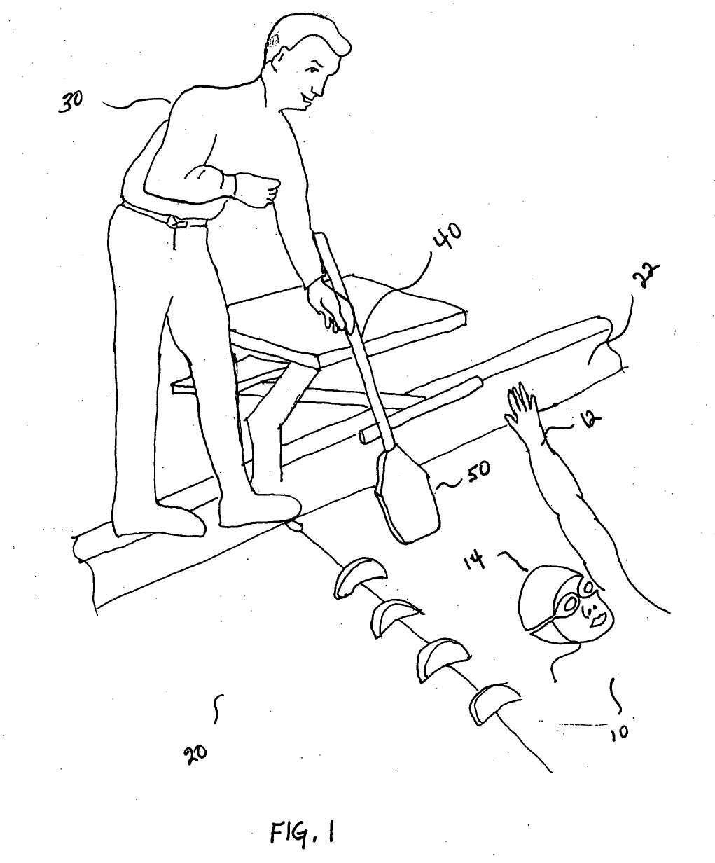

A novel apparatus and method that would enable the parents or volunteers in easily and effectively protecting the young participants from striking the crown of their heads against the pool edge at the completion of swimming the backstroke without obstructing the stroke of the swimmers as they complete swim “into the wall” will now be described with reference to FIG. 1, according to the preferred embodiment of the invention. In FIG. 1, the participant 10 is completing a backstroke in the swimming pool 20 and touching the swimming pool edge 22 with the hand 12. In order to provide a cushion between the crown of the head 14 and the swimming pool edge 22, in the event the crown of the head 14 strikes the swimming pool edge 22, the parent 30 positions the swimmer head protection apparatus 40 by lowering it into the water in a manner such that the pad or the cushion 50 is positioned in the swimming pool 20 between the edge or the side of the pool 22 and the crown of the head 14 as the swimmer 10 approaches the swimming pool wall. The protection apparatus 40 is sized such that it can be easily moved around and appropriately positioned with respect to the swimmers head 14 and the edge 22 as the need arises, in a manner such that while providing the protection, the apparatus 40 leaves the edge 22 open around the head 14 so as to provide room for the hand 12 to touch the edge 22 during the backstroke; or in other words enable completion of the backstroke “into the wall.”. The protection apparatus disclosed herein is easy to use by anyone and reliable and useful in any pool, including “no-wake” pools. The advantage of the protection apparatus disclosed herein is that the user can reach further down in the water, and prevent an injury to the swimmer by providing a better cushion for the young swimmer. Furthermore, the swimmers will perform better in terms of swimming time knowing that they will not get injured by bumping into the swimming pool wall.

In another embodiment of the invention, the protection apparatus is used as a means of notification, or notification apparatus, to the swimmer that the pool wall is near. In this application, the trainer or volunteer holds the apparatus straight out over the pool for the swimmer to see it overhead before the swimmer drives his or her arm back and makes the final drive to the pool edge. This serves as the second phase of training for backstroke swimmers after use of the apparatus against the pool edge for protection. It can also be used in this manner for highly competitive swim meets that do not permit the possible obstruction of anything in the water. The apparatus can be used in this manner when an electric touch pad is deployed against the swimming pool wall for sensing the swimmer's touch for timing purposes. The apparatus is particularly useful with younger swimmers since their stroke inconsistency and timing do not spare them from the potential of striking their heads against the pool wall. Whereas the prior art flags over pool are for swimmers to count their strokes into the pool wall, the protection apparatus when used in this manner provides a closer notification of the pool edge to the swimmer.

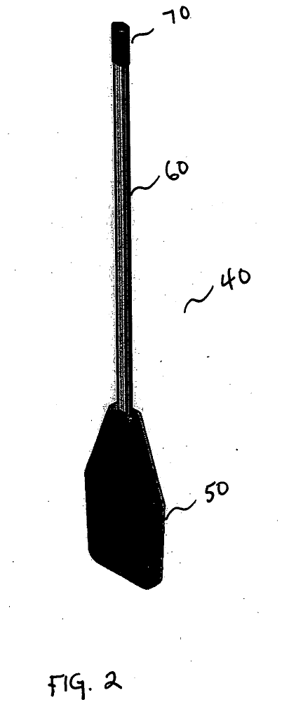

FIG. 2 illustrates a perspective view of the swimmer head protection apparatus 40 shown in FIG. 1, according to the preferred embodiment of the invention. The apparatus 40 comprises the cushion 50, the handle 60 and the cap 70. The cushion 50 is attached to the handle 60. The cap 670 is also attached to the handle 60. The cushion 50 is made from material that would provide adequate cushioning effect between the crown of the head of a swimmer and the edge of the swimming pool wall preventing the head directly hitting the swimming pool wall. According to a preferred embodiment of the invention, the cushion is made from EVA foam or PVC. According to another embodiment of the invention, the cushion is made form inflatable device. However, one skilled in the art would appreciate that the cushion can very well be made from other suitable materials as well. The preferred shape of the cushion, as shown in FIG. 2, is trapezoidal; however, one skilled in the art would appreciate that other shapes, including rectangular shape or square shape, are possible. The handle 60 is preferably made in the tubular shaped shaft; however, one skilled in the art would appreciate that other shapes for the handle, such as solid configuration, are equally possible. The handle 60 is preferably made from PVC extrusion. The handle cross-section could be oval, circular, rectangular, square, or in any other shape. Preferably, the handle 60 has a length such that it would enable a user to remain in a standing position while using the protection apparatus. Alternatively, the length of the handle 60 could be shortened such that it would enable a user to remain in a sitting position while using the protection apparatus. Alternatively, the length of the handle 60 could be adjustable. The cap 70 is shown in one preferred configuration in FIG. 2. However, one skilled in the art would appreciate that other configurations for the cap 70 are possible. In one embodiment of the invention, not shown in FIG. 2, the protection apparatus 40 comprises the cushion 50 and the handle 60, absent the cap. According to a preferred embodiment of the invention, the protection apparatus is made light weight so that it can be quickly and easily maneuvered. A sufficiently long shaft or adjustable shaft for the handle 60 allows the spotter to place the cushion in the exact location between the swimmer's head and the pool edge with minimal effort and can be placed without impeding the swimmer's stroke. The invention disclosed herein solves the problem of swimmers striking their heads on the pool edge by: 1) cutting down on effort and ability to reach down into the water; 2) allowing the spotters to remain upright or minimally bent over and thereby alleviate the imbalance that could land them in the pool; 3) reducing the reaction time because the physical response is less evasive; 4) increasing the percentage of success due to the ability to maneuver the devise across the lane edge; even with the diver platform interference; and 5) reaching the head of the swimmer regardless of the distance between the water and pool deck when “no wake” pools can make it impossible to reach the swimmer's head. The protection can all be realized without obstructing the stoke of the swimmer as the swimmer completes swim “into the wall.” For the coach or trainer the protection apparatus serves to safely teach the young student swimmers the proper completion of the backstroke without the continual discomfort of the students head hitting the pool edge. With the aid of the protection apparatus, the student swimmers can safely execute their completion in real time as fast as possible without the fear of injury. For the competitive swimmer in a meet, with the aid of the protection apparatus, the swim time can be reduced because the swimmer will not slow down prior to completion due to the fear of injury from swimming into the pool edge.

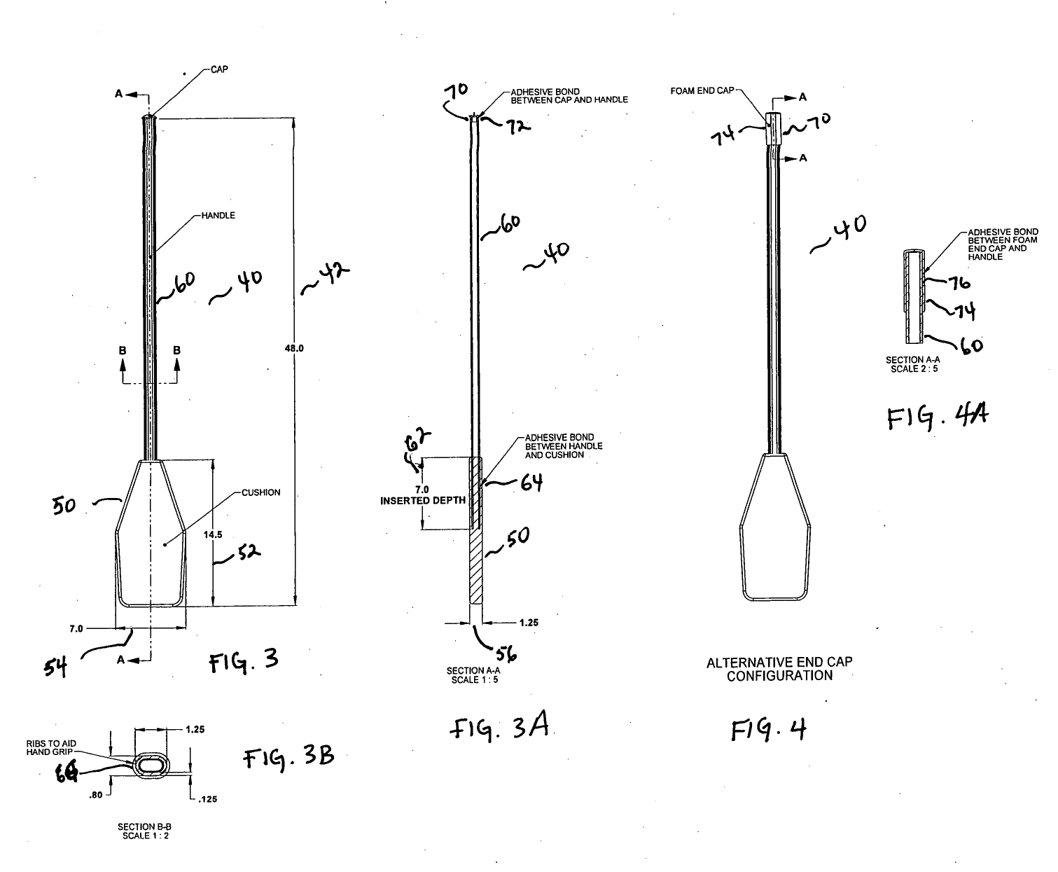

FIGS. 3, 3A and 3B show typical assembly, cross sectional views, and several dimensions regarding a preferred embodiment of the swimmer head protection apparatus.

FIG. 3 illustrates the front view of and preferred dimensions for the swimmer head protection apparatus 40 shown in FIGS. 1 and 2, according to a preferred embodiment of the invention. The dimensions shown in FIG. 3 are in inches. The total height 42 of the protection apparatus 40 is 48.0 inches. The height 52 and the width 54 of the cushion 50 are 14.5 inches and 7.0 inches, respectively. Although not shown, the rear view of the protection apparatus 40 is similar to the front view shown in FIG. 3. However, a different rear view of the protection apparatus is quite possible.

FIG. 3A illustrates an enlarged view of the cross-section of the protection apparatus taken along the section marked A-A of the protection apparatus 40 in FIG. 3, according to a preferred embodiment of the invention. The dimensions shown in FIG. 3 are in inches. The thickness 56 of the cushion is 1.25 inches. The insertion depth 62 of one end of the handle 60 into the cushion 50 is 7.0 inches. There is an adhesive bond 64 applied to the handle section 62 between the handle 60 and the cushion 50. There is also an adhesive bond 72 applied between the other end of the handle 60 and the cap 70.

FIG. 3B illustrates an enlarged view of the cross-section of the protection apparatus taken along the section marked B-B of the handle 60 in FIG. 3, according to a preferred embodiment of the invention. The handle cross-section is shaped in an oval, hollow tubular shape, with various dimensions as shown in FIG. 3B. Ribs 66 are placed on the handle to aid in gripping the handle.

One skilled in the art would appreciate that other dimensions besides those shown in FIGS. 3, 3A and 3B are equally possible, and that the present invention is not limited to these specific dimensions only.

FIG. 4 illustrates an alternate configuration 74 made of foam for the cap 70 of the swimmer head protection apparatus 40, according to an alternate embodiment of the invention.

FIG. 4A illustrates an enlarged view of the cross-section of the cap 74 made of foam and a portion of the handle 60 taken along the section marked A-A in FIG. 4, showing adhesive bond between the cap 74 and the handle 60, according to an alternate embodiment of the invention.

Although the apparatus disclosed herein is for providing a protective cushion between the edge of the swimming pool wall and the crown of the head of a swimmer, one skilled in the art would appreciate that the apparatus may be used to provide protection in other applications as well.

Persons skilled in the art will appreciate that variation from the details of the presently preferred and alternative embodiments may be made without departure from the true scope and spirit of the invention. The true scope is to be determined by reference to the appended claims.

We claim:

1. A protection apparatus, comprising:
a handle; said handle having a top end and a bottom end;
and a cushion attached to said handle at said bottom end; wherein said cushion is placed, when desired, between a first object and a second object for providing protection to the second object when the second object strikes the first object.

2. The protection apparatus of claim 1, wherein said first object is an edge of a wall of a swimming pool and the second object is the crown of the head of a swimmer.

3. The protection apparatus of claim 1, wherein said handle has a length such that it would enable a user to remain in a standing position while using the protection apparatus.

4. The protection apparatus of claim 1, wherein said handle has a length such that it would enable a user to remain in a sitting position while using the protection apparatus.

5. The protection apparatus of claim 1, wherein said handle has an adjustable length.

6. The protection apparatus of claim 1, wherein said handle is made from a tubular PVC extrusion shaft having ridges on the out side surface, and having the cross-section shaped in an oval shape.

7. The protection apparatus of claim 1, wherein said cushion is made of protective material.

8. The protection apparatus of claim 1, wherein said cushion is made of EVA foam or PVC.

9. The protection apparatus of claim 1, wherein said protective material is made of an inflatable device.

10. The protection apparatus of claim 1, wherein the front side and the back side of said cushion each is shaped in the form of a trapezoid.

11. The protection apparatus of claim 1, wherein the front side and the back side of said cushion each is shaped in the form of a rectangle.

12. The protection apparatus of claim 1, wherein the front side and the back side of said cushion each is shaped in the form of a square.

13. The protection apparatus of claim 1, wherein said cushion is 1.25 inches thick.

14. The protection apparatus of claim 1, wherein a cap is placed on said top end of said handle.

15. A method of protecting the crown of a swimmer's head from striking an edge of a wall of a swimming pool, comprising the steps of:
holding a protection apparatus comprising a handle and a cushion; said handle having a top end and a bottom end; said cushion being attached to said handle at said bottom end; and
positioning said protection apparatus so that said cushion is placed between the edge of the wall of the swimming pool and the crown of the head of the swimmer.

16. The method of claim 15, wherein said handle has a length such that it would enable a user to remain in a standing position while positioning the protection apparatus.

17. The method of claim 15, wherein said handle has an adjustable length.

18. The method of claim 15, wherein said handle is made from a PVC extrusion tubular shaft having ridges on the out side surface, and having the cross-section shaped in an oval shape.

19. The method of claim 15, wherein said cushion is made of protective material.

20. The method of claim 15, wherein said cushion is made of EVA foam or PVC.

21. The method of claim 15, wherein said protective material is made of an inflatable device.

22. The method of claim 15, wherein the front side and the back side of said cushion each is shaped in the form of a trapezoid.

23. The method of claim 15, wherein the front side and the back side of said cushion each is shaped in the form of a rectangle.

24. The method of claim 15, wherein the front side and the back side of said cushion each is shaped in the form of a square.

25. The method of claim 15, wherein said cushion is 1.25 inches thick.

26. The method of claim 15, wherein a cap is placed on said top end of said handle.

27. A method of notification to the swimmer that the pool wall is near, comprising the steps of:
holding a protection apparatus comprising a handle and a cushion; said handle having a top end and a bottom end; said cushion being attached to said handle at said bottom end; and
positioning said protection apparatus straight out over the pool for the swimmer to see said apparatus overhead before the swimmer drives his or her arm back and makes the final drive to the pool edge.

28. The method of claim 27, wherein said handle has a length such that it would enable a user to remain in a standing position while positioning the protection apparatus.

29. The method of claim 27, wherein said handle is made from a PVC extrusion tubular shaft having ridges on the out side surface, and having the cross-section shaped in an oval shape.

30. The method of claim 27, wherein the front side and the back side of said cushion each is shaped in the form of a trapezoid.
